(19) United States
(12) Patent Application Publication
(10) Pub. No.: US 2011/0050504 A1
(43) Pub. Date: Mar. 3, 2011

(54) Multiple-connected microstrip lines and the design methods thereof

(76) Inventor: Chi-Liang Ni, Taipei City (TW)

(21) Appl. No.: 12/078,458

(22) Filed: Mar. 31, 2008

(51) Int. Cl. H01Q 1/38; G06F 17/50

(52) U.S. Cl. 343/700 MS; 716/137

(57) ABSTRACT

This invention discloses a new structure, multiple-connected-microstrip-line, based on microstrip line and the design methods of using this new structure for various electromagnetic components, which transmit, feed-in/feed-out, store/release, and radiate/receive electromagnetic signals with improved characteristics, such as Quality factor, broadband impedance matching, interference immunity, and radiation patterns in the applications, such as transmission lines, impedance transformers, inductors, antennas etc. Comparing with traditional microstrip line, the additional topological parameters of multiple-connected microstrip line allow the designers to improve broadband characteristics without increasing the size of the electromagnetic components.

### BACKGROUND OF THE INVENTION

This invention relates to the fields of transmission lines, waveguides, inductors, antennas and more specifically to a new transmission line structure, which comprises a plurality of microstrip lines connected together for improving electromagnetic characteristics such as impedance matching, inductor Quality (Q) factor, antenna radiation patterns, signal interference etc.

Microstrip line, shown as in FIG. 1, has been adopted as a basic structure for transmitting, feeding, storing, and radiating electromagnetic signals for years. One of main advantages is its simple structure, which is easy to manufacture and to integrate with other structures. However, this structure is susceptible to signal interference than other structures, such as striplines. Two widely referred papers related to microstrip lines are listed as follows:
H. A. Wheeler, “Transmission-Line Properties of Parallel Strips Separated by a Dielectric Sheet,” IEEE Trans. on Microwave Theory &. Techniques, Vol. 3, No. 3, March 1965, pp. 172-185.
H. A. Wheeler, “Transmission-Line of a Strip on a Dielectric Sheet on a Plane,” IEEE Trans. on Microwave Theory & techniques, Vol. 25, No. 8, August 1977, pp. 631-647.

Recently, the electronic hardware becomes miniature. This trend is observed in all aspects of hardware technologies and materials, such as PCB, integrated circuits (IC), antennas, etc. The use of microstrip lines in conjunction with these technologies and materials suffers from two drawbacks. Firstly, due to miniaturization, the signals in microstrip lines become susceptible to the closer electromagnetic structures in the neighborhood; secondly, due to miniaturization, skin effect becomes more prominent, and subsequently the impedance of microstrip line varies sensitively with signal frequencies. In order to improve the frequency response and Q factor, particularly for broadband applications, there are inventions modifying the structures related to microstrip line.

For example, a prior art U.S. Pat. No. 6,750,750 teaches a multiple-parallel-line structure on the top of a conductive line of a spiral inductor as shown in FIG. 2. Another prior art U.S. Pat. No. 6,853,097 teaches a multiple-fins structure extend away from a based region of a conductive line of an inductor as shown in FIG. 3. And another prior art U.S. Pat. No. 6,885,275 teaches a multiple-tracks-conductive-line structure joined at ends on a single layer or joined through via holes for the structure on multiple layers as shown in FIG. 4.

However, these prior arts apply only to the on-chip inductors of integrated circuits and the teaching structures are not exactly the microstrip lines due to the involved architectures of integrated circuits. Therefore, these prior arts are applicable limited to the indicated area.

### SUMMARY OF THE INVENTION

The primary object of the present invention is to provide a multiple-connected microstrip line, which comprises a plurality of microstrip lines connected by a plurality of conductive segments for forming a single electrically connected structure, thereby keeps the simple construction for easily integrating with other structures, meanwhile mitigates susceptibility of signal interference caused by miniaturization, improves the desirable electromagnetic characteristics, and increases the areas of applications.

A further object of the present invention is to provide design methods for designing multiple-connected-microstrip-line components, which transmit, feed-in/feed-out, store/release, and radiate/receive electromagnetic signals with improved Q factor, broadband impedance matching, interference immunity, and radiation patterns in the areas of transmission lines, impedance transformers, inductors, antennas etc.

Another further object of the present invention is to provide design methods for designing multiple-connected-microstrip-line components, which transmit, feed-in/feed-out, store/release, and radiate/receive electromagnetic signals with improved Q factor, broadband impedance matching, interference immunity and radiation patterns in the structures with single layer or a plurality of layers of metallic, semiconductor, and dielectric materials, such as those used for building integrated circuits (IC), thin film transistors (TFT), low temperature co-fired ceramics (LTCC), high temperature co-fired ceramics (HTCC), printed circuit board (PCB), carbon nanotube (CNT) etc.

### BRIEF DESCRIPTION OF THE DRAWINGS

FIG. 1 is a prior art—Microstrip line;

FIG. 2 is a prior art—Multiple-parallel-line on the top of a conductive line;

FIG. 3 is a prior art—Multiple-fin conductive line;

FIG. 4 is a prior art—Multiple-track conductive line;

FIG. 5 illustrates Multiple-connected microstrip line structure in this invention;

FIG. 6 is an embodiment of multiple-connected microstrip line as a transmission line;

FIG. 7 is another embodiment of multiple-connected microstrip line comprises feed-in, feed-out and via hole to ground conductor;

FIG. 8 is another embodiment of multiple-connected microstrip line comprises feed-in and feed-out;

FIG. 9 is an embodiment of transmission line designed by the prior art—Microstrip line;

FIG. 10 is an embodiment of transmission line designed by the structure of this invention, multiple-connected microstrip line;

FIG. 11 is the S parameters (S₁₁, S₂₂, and S₂₁) of transmission line designed by the prior art—Microstrip line (FIG. 9);

FIG. 12 is the S parameters (S₁₁, S₂₂, and S₂₁) of transmission line designed by the structure of this invention, multiple-connected microstrip line (FIG. 10);

FIG. 13 is an embodiment of antenna designed by the prior art—Microstrip line;

FIG. 14 is an embodiment of antenna designed by the structure of this invention, multiple-connected microstrip line;

FIG. 15 is the Total Field gain vs. Frequency plot of antenna designed by the prior art—Microstrip line (FIG. 13);

FIG. 16 is the Total Field gain vs. Frequency plot of antenna designed by the structure of this invention, multiple-connected microstrip line (FIG. 14);

FIG. 17 is the Elevation Radiation pattern plot of antenna designed by the prior art—Microstrip line (FIG. 13);

FIG. 18 is the Elevation Radiation pattern plot of antenna designed by the structure of this invention, multiple-connected microstrip line (FIG. 14).

### DETAILED DESCRIPTION OF THE PREFERRED EMBODIMENT

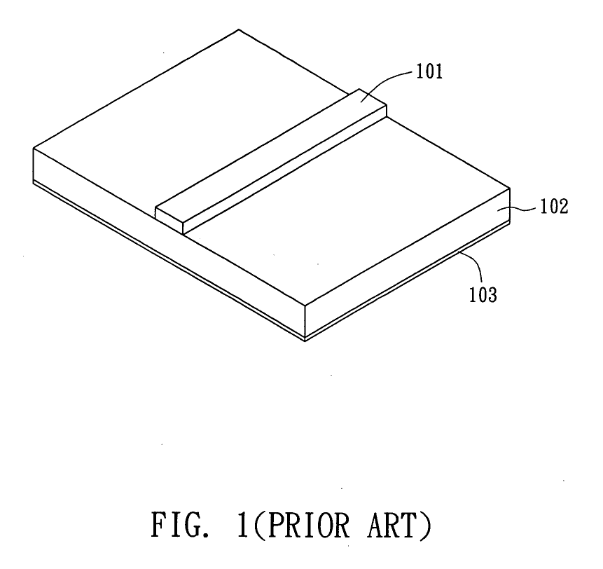

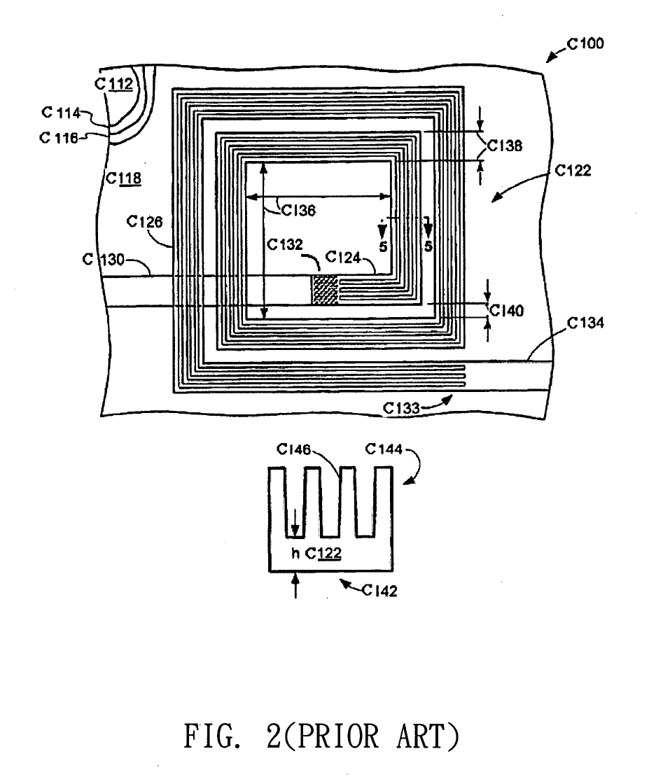

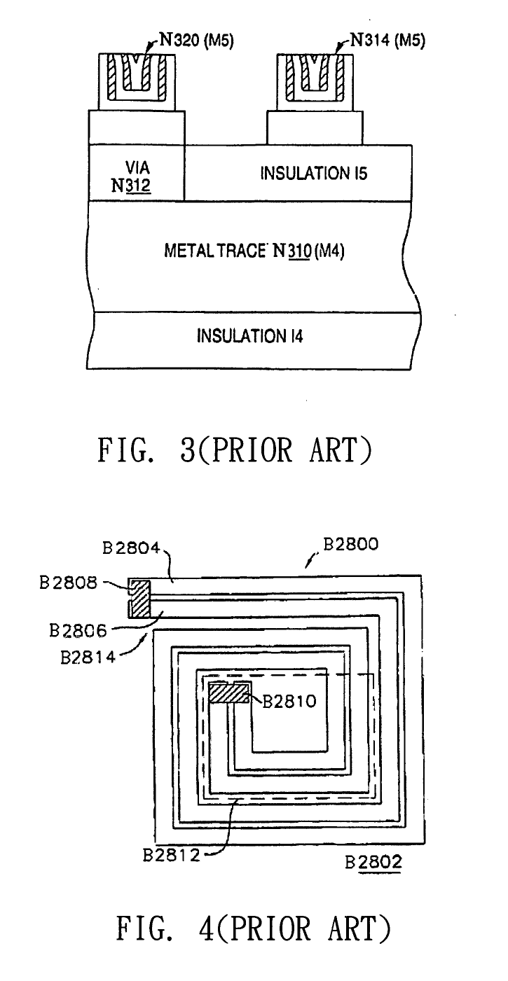

FIG. 1 shows a known microstrip line comprises signal conductor 101, dielectric material 102, and ground conductor 103.

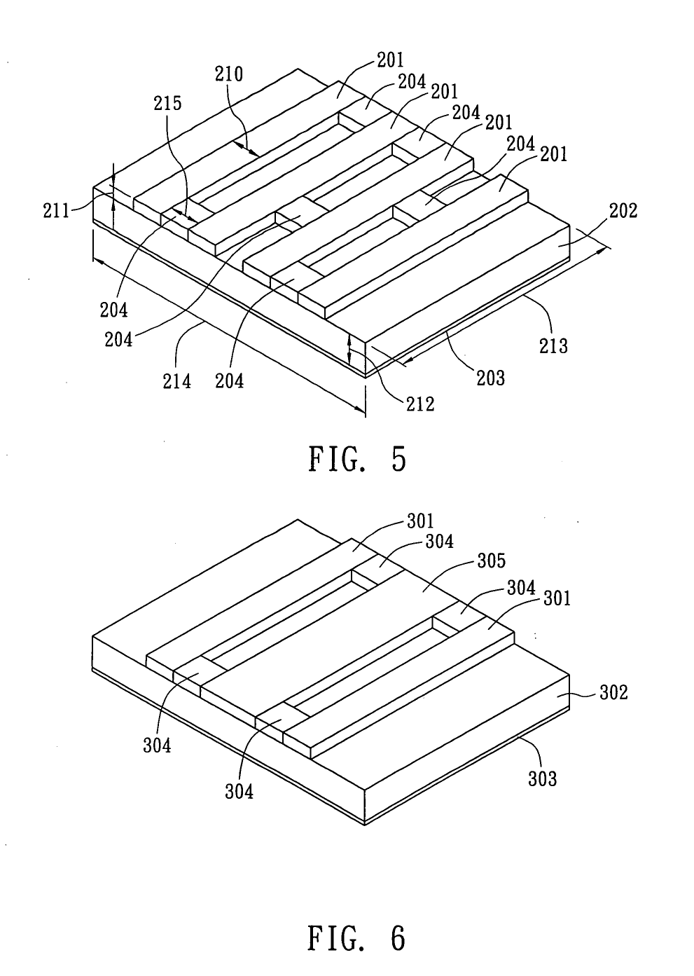

FIG. 5 shows the structure of this invention, multiple-connected microstrip line comprising signal conductors 201, dielectric material 202, ground conductor 203, conductive segments 204 for connecting signal conductors 201; 210 represents the width of signal conductor 101; 211 represents the height of signal conductor 101; 212 represents the height of dielectric material; 213 represents the length of dielectric material and ground conductor; and 214 represents the width of dielectric material and ground conductor. A multiple-connected microstrip line comprises two or more than two signal conductors. 215 represents the distance between two adjacent signal conductors. This distance 215 is also the width of conductive segments 204. The length, height, and width of the individual signal conductors 201 are not necessarily the same. The length, height, and width of the individual conductive segments 204 are not necessarily the same either. A plurality of connecting positions among signal conductors and conductive segments forms a connecting pattern of a multiple-connected microstrip line.

Based on different connecting patterns and different dimensions of the signal conductors and conductive segments, the electromagnetic characteristics of multiple-connected microstrip line, such as resistance, capacitance, and inductance, will vary with the signal frequencies, consequently the S parameters, Q factor, radiation gain, and radiation pattern will reflect these variations.

FIG. 6 is an embodiment of transmission line designed by multiple-connected microstrip line. This embodiment comprises three signal conductors with a wide signal conductor 305 at center and two narrow signal conductors 301 on both sides. These signal conductors are connected by conductive segments 304. The narrower signal conductors with higher impedance shield the undesirable signal interference from external environment when the major part of electromagnetic energy transmits through the central signal conductor.

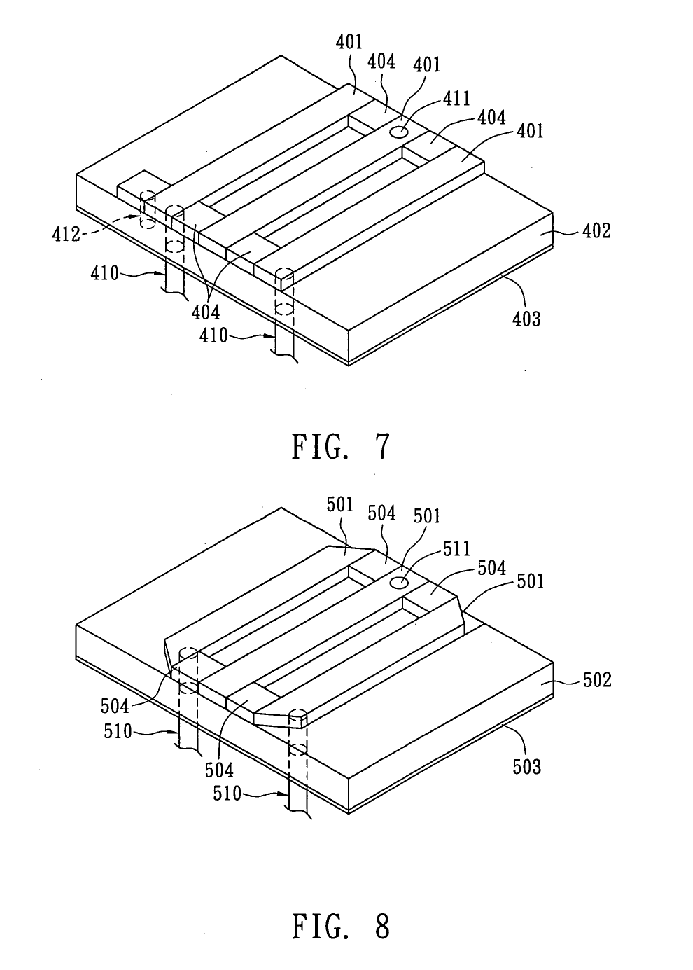

For an unbalanced feed-in, we can connect the signal conductor of a coaxial cable to the signal conductor 101 of a traditional microstrip line and ground shield of the coaxial cable to the ground conductor 103 (FIG. 1). FIG. 7 shows an embodiment of two signal feed-in points 410 to two signal conductors 401, which extending to the other side of multiple-connected microstrip line, and therein connected to a third signal conductor 401 by conductive segments 404. A signal feed-out 411 connected to the third signal conductor passes the signal to a coaxial cable by the same manner as feed-in. The construction of feed-in and feed-out is not limited to the current form. Signal conductor 401 can be also connected to a conductive or semi-conductive via hole 412 to the ground conductor 403 by the conductive segment 404 through dielectric material 402. FIG. 8 is an another embodiment showing different designs of feed-in 510, signal conductors 501, conductive segments 504, and feed-out 511. In this FIG. 502 represents the dielectric material and 503 represents ground conductor. FIG. 7 and FIG. 8 show that a multiple-connected microstrip line can be constructed on a signal layer or a plurality of layers by different connecting configurations of feed-in, feed-out, and via hole.

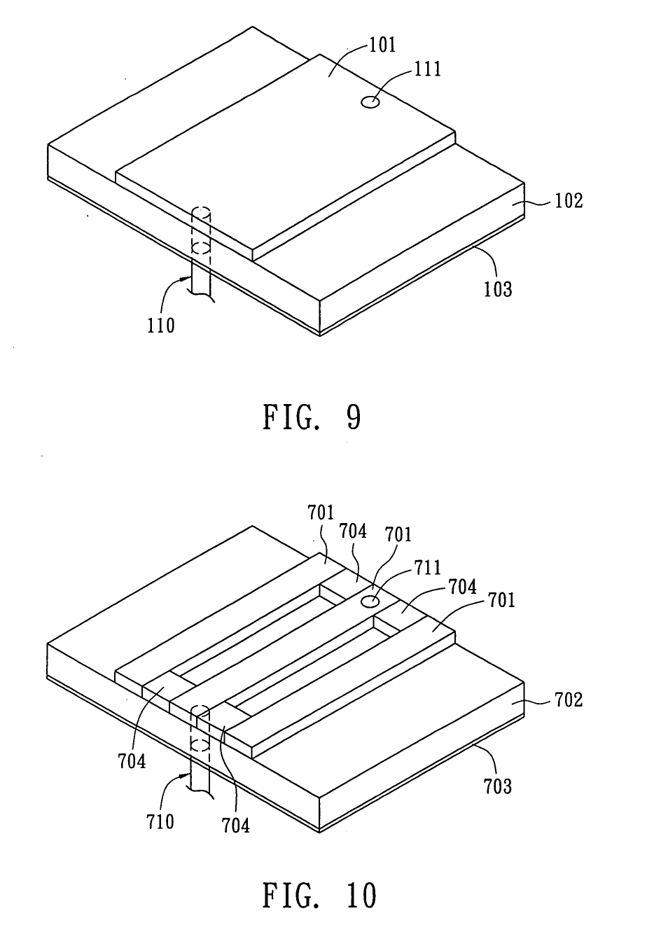

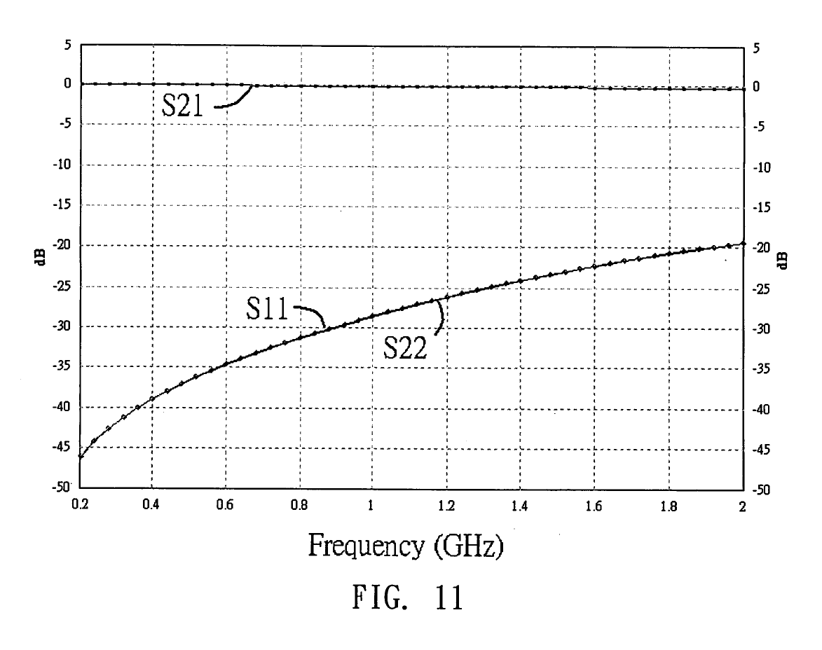

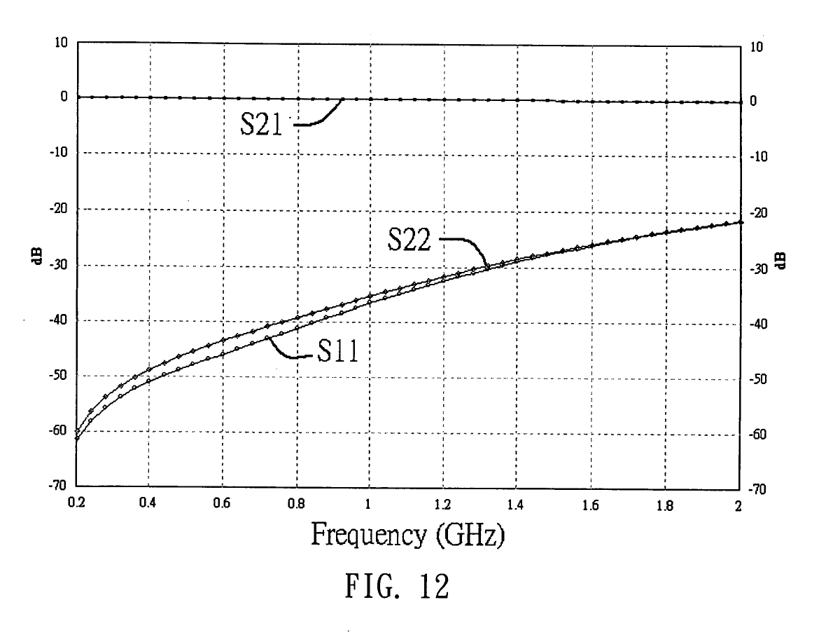

FIG. 9 is a microstrip line designed as a transmission line with signal conductor 101, dielectric material 102, ground conductor 103, feed-in 110, and feed-out 111. FIG. 10 shows a multiple-connected microstrip line designed as a transmission line with three signal conductors 701, conductive segments 704, feed-in 710, feed-out 711, dielectric material 702, and ground conductor 703. The total width including three signal conductors and two conductive segments of the multiple-connected microstrip line is same as the width of microstrip line in FIG. 9. FIG. 11 shows the S parameters (S₁₁, S₂₂, and S₂₁) from 0.2 GHz to 2 GHz of transmission line designed by the traditional microstrip line (FIG. 9); and FIG. 12 shows S₁₁, S₂₂, and S₂₁ of transmission line in the same frequency range designed by multiple-connected microstrip lines (FIG. 10). From these plots, we observe that the additional topological parameters of multiple-connected microstrip line, such as the widths and the separating distances of signal conductors, allow the designers to improve the frequency response and Q factor of transmission line over a broad bandwidth.

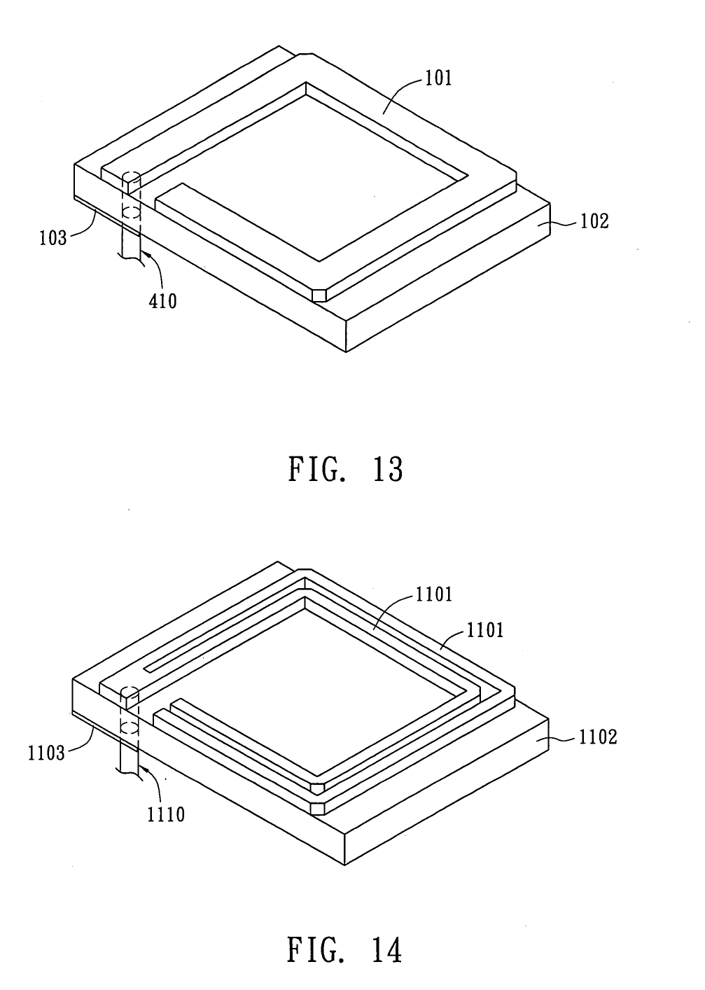

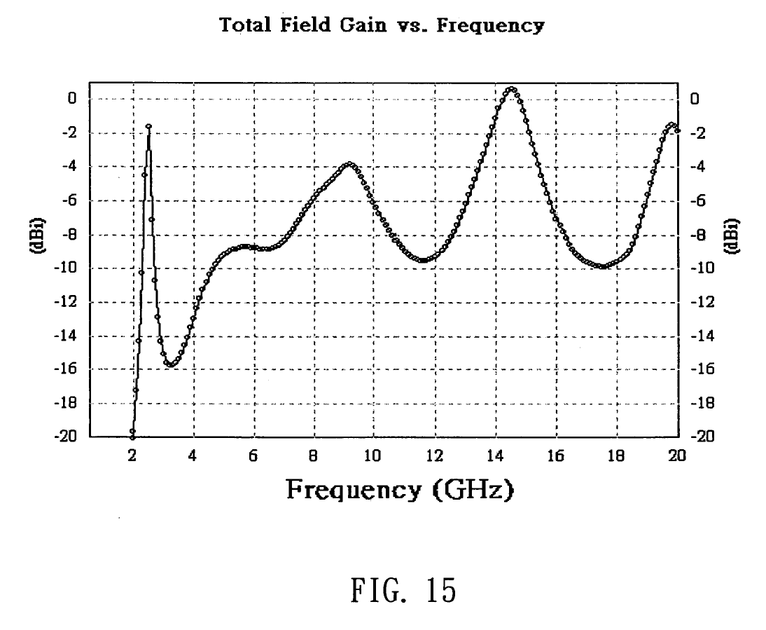

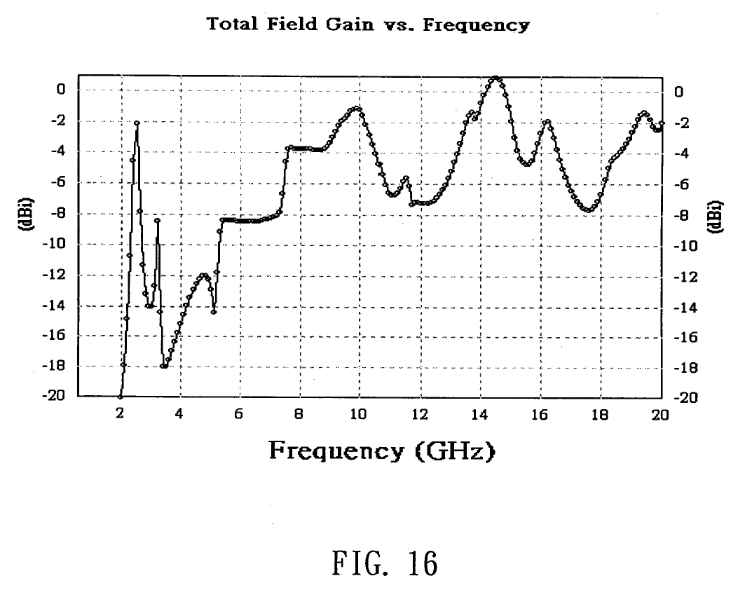

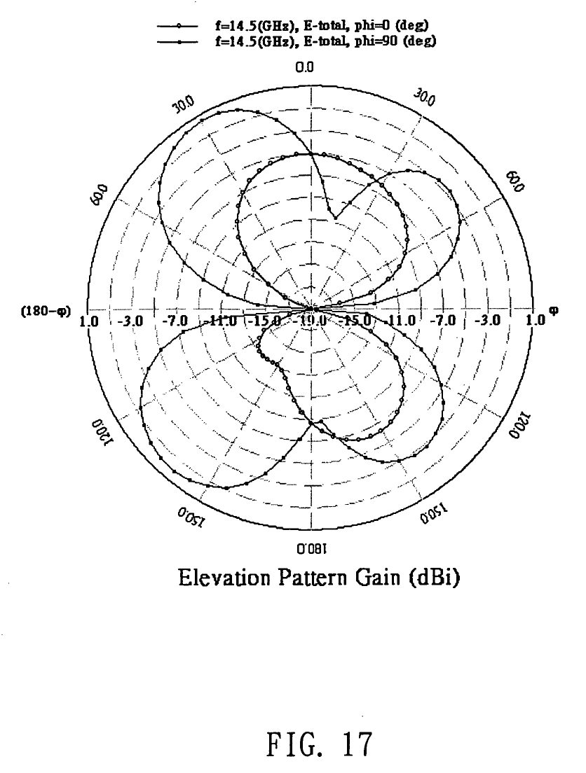

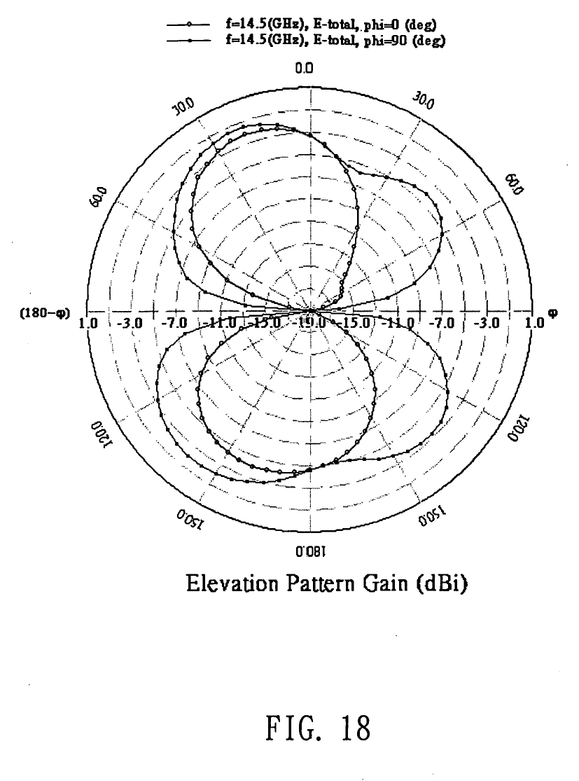

FIG. 13 is a microstrip line designed as an antenna with signal conductor 101, dielectric material 102, ground conductor 103, and feed-in 410. The ground conductor only partially covers the dielectric material 102. FIG. 14 shows a multiple-connected microstrip line designed as an antenna with two signal conductors 1101, dielectric material 1102, ground conductor 1103, and feed-in 1110. All dimensions of this design are same as those in FIG. 13 except the signal conductors 1101. The total width including two signal conductors and the gap between two signal conductors of the multiple-connected microstrip line is same as the width of microstrip line 101 in FIG. 13. FIG. 15 shows the Total Field gain vs. Frequency plot of antenna designed by traditional microstrip line (FIG. 13). And FIG. 16 shows the Total Field gain vs. Frequency plot of antenna designed by multiple-connected microstrip lines (FIG. 14). FIG. 17 shows the Elevation Radiation pattern plot of antenna designed by microstrip line (FIG. 13); and FIG. 18 shows the Elevation Radiation pattern plot of antenna designed by the multiple-connected microstrip lines (FIG. 14). Again, from these plots, we observe that the additional topological parameters of multiple-connected microstrip line allow the designers to improve gain and radiation pattern of broadband antennas.

From the embodiments disclosed above, FIG. 10 shows that the multiple-connected microstrip line comprises three signal conductors as part of a transmission line, and FIG. 14 shows that the multiple-connected microstrip line comprises two signal conductors as part of an antenna. These embodiments represent two connecting patterns of the multiple-connected microstrip line.

Although the present invention has been described in the detailed embodiments, a myriad of changes, variations, alterations, transformations and modifications may be suggested to one skilled in the art, and it is intended that the present invention encompass such changes, variations, alternations, transformations and modifications that fall within the spirit and scope of the appended claims.

What is claimed is:

1. A multiple-connected microstrip line, comprising:
a plurality of signal conductors of microstrip line;
a ground conductor; and
a dielectric material which separates the signal conductors and ground conductor;
wherein said signal conductors are connected by a plurality of conductive segments for forming a single conductor.

2. The multiple-connected microstrip line as in claim 1, wherein the plurality of signal conductors have different widths, heights, and lengths, wherein the dielectric material has different widths, heights, and lengths.

3. The multiple-connected microstrip line as in claim 1, wherein the plurality of signal conductors connected by the plurality of conductive segments at different positions forms different connecting patterns, consequently produces different electromagnetic characteristics of the multiple-connected microstrip line.

4. The multiple-connected microstrip line as in claim 1, wherein the ground conductor forms different shapes.

5. The multiple-connected microstrip line as in claim 1, wherein the dielectric material forms different shapes.

6. The multiple-connected microstrip line as in claim 1, wherein the materials for the plurality of signal conductors include different metallic and semiconductor materials.

7. The multiple-connected microstrip line as in claim 1, wherein the materials for the plurality of conductive segments include different metallic and semiconductor materials.

8. The multiple-connected microstrip line as in claim 1, wherein the materials for the ground conductor include different metallic and semiconductor materials.

9. The multiple-connected microstrip line as in claim 1, wherein the materials for dielectric material include different dielectric materials.

10. A method for designing electromagnetic components using multiple-connected microstrip line, comprising:
determine at least one type of the components from the category of transmission, feeding, storage/release, and radiating/receiving of electromagnetic signals;
determine the number of signal conductors;
determine the distances of signal conductors;
determine the lengths, widths, and heights of signal conductors;
determine the lengths, widths, and heights of conductive segments and connecting positions to the signal conductors;
determine points of feed-in and feed-out;
determine the positions of via holes to the ground conductor; and
iterate above steps or part of the steps, to produce the characteristic sets of the component are in the desirable ranges.

11. The method as in claim 10, wherein the component transmits electromagnetic signals, therein the multiple-connected microstrip line comprises a plurality of signal feed-in and feed-out.

12. The method as in claim 10, wherein the component stores/releases electromagnetic signals, therein the multiple-connected microstrip line comprises a plurality of signal feed-in and feed-out.

13. The method as in claim 10, wherein the component radiates/receives electromagnetic signals, therein the multiple-connected microstrip line comprises a plurality of signal feed-in and via hole to the ground conductors.

14. The multiple-connected microstrip line as in claim 10, wherein the multiple-connected microstrip line comprises a plurality of layers of signal conductors, dielectric material, and ground conductor by different connecting configurations of feed-in, feed-out, and via hole.
